(19) United States
(12) Patent Application Publication
(10) Pub. No.: US 2010/0057234 A1
(43) Pub. Date: Mar. 4, 2010

(54) INFORMATION PROCESSING APPARATUS, LIGHT EMISSION CONTROL METHOD AND COMPUTER PROGRAM

(75) Inventors: Yuki MURATA, Tokyo (JP); Soichiro ATSUMI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/544,518

(22) Filed: Aug. 20, 2009

(30) Foreign Application Priority Data
Aug. 26, 2008 (JP) 2008-216152

(51) Int. Cl. G06F 17/00; G06F 17/18

(52) U.S. Cl. 700/94; 706/11

(57) ABSTRACT

An information processing apparatus of the present invention is provided with a musical composition storing unit for storing musical composition data, a reproducing unit for reproducing the musical composition, a meta information storing unit for storing meta information including a position of the musical data and an amount of characteristic indicating characteristics of the musical composition data at the position, an amount of characteristic obtaining unit for obtaining the amount of characteristic at a reproduction position of the musical composition data reproduced by the reproducing unit at predetermined timing, and a blink control unit for controlling a blink of an light emitting unit for emitting light according to the amount of characteristic obtained by the amount of characteristic obtaining unit.

### BACKGROUND OF THE INVENTION

1. Field of the Invention

The present invention relates to an information processing apparatus, a light emission control method and a computer program.

2. Description of the Related Art

With the development of a digital audio player, music, voice and the like are recently handled as digital musical composition data. Recently, a number of music download distribution sites for distributing musical composition data via Internet are launched, so that musical compositions may be easily obtained by using a personal computer. Also, there are various music playing applications for reproducing the musical composition data on the personal computer.

On the other hand, there are cases in which when the music is played, a light emitting unit such as an LED provided on a device emits light. For example, Japanese Patent Application Laid-Open No. 2003-273969 discloses a cell-phone in which a user sets a lighting color corresponding to a sound pitch in advance to generate a lighting color change pattern of each musical composition based on the set lighting color. Such cell-phone allows an LED to emit light according to the lighting color change pattern of the musical composition when the musical composition is reproduced as a ring alert. This makes it possible to inform the user of an incoming call even when the cell phone is muted by setting such as a manner mode, for example. At that time, it is possible to grasp the musical composition being reproduced by the lighting color change pattern, so that if the ring alert and a caller are made correspond to each other, the caller may be grasped also.

[Patent Document 1] Japanese Patent Application Laid-Open No. 2003-273969

### SUMMARY OF THE INVENTION

However, many of the music playing applications in related art in the personal computer have only a function to merely play the music and display related information relating to the music being played, and as an additional function, an equalizer indicating a sound volume is merely provided. Although a multifunctional music playing application has been provided, many of the functions do not directly relate to a music playing function such as a link to the music distribution site on the Internet.

Also, as a home audio device, a device including the additional device such as the LED is present. However, this only temporarily blinks the LED together with user operation such as play/pause operation and volume change, and the function does not directly relate to the music playing function.

In this manner, since a degree of collaboration between the music playing function, and a body of the device and the music playing application is low, it is difficult to improve immersive feeling of the user in looking at and listening to the music, so that this has been often used as a BGM while doing other works.

Then, the present invention is made in view of the above-described problem, and it is desirable to provide novel and improved information processing apparatus, light emission control method and computer program, capable of realizing the blink of the light emitting unit integrated with the music playing function.

According to an embodiment of the present invention, there is provided an information processing apparatus including: a musical composition storing unit for storing musical composition data; a reproducing unit for reproducing the musical composition data; a meta information storing unit for storing meta information including a position of the musical composition data and an amount of characteristic indicating characteristics of the musical composition data at the position; an amount of characteristic obtaining unit for obtaining the amount of characteristic at a reproduction position of the musical composition data reproduced by the reproducing unit at predetermined timing; and a blink control unit for controlling a blink of a light emitting unit for emitting light according to the amount of characteristic obtained by the amount of characteristic obtaining unit.

According to an embodiment of the present invention, the amount of characteristic is judged every position of the musical composition data by using the position of the musical composition data and the amount of characteristic of the musical composition at each position of the musical composition data included in the meta information to blink the light emitting unit based on the amount of characteristic. Herein, the position of the musical composition data refers to the position specified by time based on a time axis. Thereby, the blink of the light emitting unit conforming to the timing of the musical composition now being reproduced may be realized.

Here, the meta information includes information regarding a beat being associated with the position of the musical composition data. Then, the amount of characteristic obtaining unit may obtain the amount of characteristic of the musical composition data at timing of the beat.

According to another embodiment of the present invention, there is provided the information processing apparatus including: a musical composition storing unit for storing musical composition data; a reproducing unit for reproducing the musical composition data; a meta information obtaining unit for obtaining meta information in which information regarding reproduced musical composition data being the musical composition data being reproduced by the reproducing unit is described; a judging unit for judging change in an amount of characteristic indicating characteristics of the reproduced musical composition data at predetermined timing based on the meta information obtained by the meta information obtaining unit; and a blink control unit for controlling a blink of a light emitting unit for emitting light when the amount of characteristic of the reproduced musical composition data changes.

According to an embodiment of the present invention, the judging unit judges whether the amount of characteristic of the reproduced musical composition data changes based on the information regarding the reproduced musical composition data included in the meta information at predetermined timing. Then, the blink of the light emitting unit is controlled when the amount of characteristic of the reproduced musical composition data changes. Thereby, it is possible to change the blink of the light emitting unit according to the characteristics of the reproduced musical composition data, and by realizing the cooperation between a musical composition reproduction function and the information processing apparatus, sense of unity may be provided to them. Also, the change in the amount of characteristic is judged every predetermined number of beats, so that even when a gap temporarily occurs in cooperation timing between the musical composition reproduction and the blink of the light emitting unit, the gap may be easily recovered.

The information processing apparatus according to the present invention can include a blink information storing unit for associating a classification pattern to classify the musical composition data with a predetermined condition and a blink pattern to blink the light emitting unit with each other to store; and a blink pattern obtaining unit for obtaining the blink pattern. Then, the blink control unit controls the blink of the light emitting unit based on the blink pattern of the reproduced musical composition data obtained by the blink pattern obtaining unit. The blink pattern may determine according to a tune of the musical composition data.

Further, the blink control unit may not blink the light emitting unit in a silent part present in the musical composition data being reproduced by the reproducing unit.

The information processing apparatus according to the present invention can include a blink judging unit for judging whether to allow the light emitting unit to emit light. Then, the blink judging unit judges when the amount of characteristic of the reproduced musical composition data changes, and the control unit controls the blink of the light emitting unit only when it is judged to allow the light emitting unit to emit light by the blink judging unit.

The information processing apparatus can include a musical composition analyzing unit for analyzing the musical composition data to obtain information regarding the musical composition data. The musical composition analyzing unit generates the meta information in which the information regarding the musical composition data is described. The blink control unit may allow the light emitting unit to emit light based on a predetermined blink pattern set in advance when the musical composition data is not analyzed by the musical composition analyzing unit.

The musical composition analyzing unit may store the generated meta information in the musical composition storing unit together with the musical composition data. Further, an information processing apparatus can include a meta information storing unit for associating the meta information in which the information regarding the musical composition data is described and the musical composition data with each other to store, then the musical composition analyzing unit may record the generated meta information in the meta information storing unit, aside from the musical composition data.

The information processing apparatus can include a display unit for displaying an operating screen for operating the reproducing unit. Then, a color tone such as background of the operating screen may be changed according to a classification pattern of the reproduced musical composition data.

According to another embodiment of the present invention, there is provided a light emission control method including the steps of: storing musical composition data; reproducing the musical composition data; recording meta information including a position of the musical composition data and an amount of characteristic indicating characteristics of the musical composition data at the position in a meta information storing unit; obtaining the amount of characteristic at a reproduction position of the musical composition data reproduced at predetermined timing; and controlling a blink of a light emitting unit for emitting light according to the obtained amount of characteristic.

According to another embodiment of the present invention, there is provided a computer program for allowing a computer to operate as: storing means for storing musical composition data; reproducing means for reproducing the musical composition data; meta information recording means for recording meta information including a position of the musical composition data and an amount of characteristic indicating characteristics of the musical composition data at the position in a meta information storing unit; amount of characteristic obtaining means for obtaining the amount of characteristic at a reproduction position of the musical composition data reproduced by the reproducing means at predetermined timing; and blink control means for controlling a blink of a light emitting unit for emitting light according to the amount of characteristic obtained by the amount of characteristic obtaining means.

According to the embodiments of the present invention, the information processing apparatus, the light emission control method and the computer program, capable of realizing the blink of the light emitting unit integrated with the music play function may be provided.

### BRIEF DESCRIPTION OF THE DRAWINGS

FIG. 1 is a plan view showing a personal computer, which is an example of an information processing apparatus according to an embodiment of the present invention, in an opened state;

FIG. 2 is a front view showing the personal computer, which is an example of the information processing apparatus according to this embodiment, in a closed state;

FIG. 3 is a bottom view showing the personal computer, which is an example of the information processing apparatus according to this embodiment, in the opened state;

FIG. 4 is an illustration diagram showing a hardware configuration of the information processing apparatus according to this embodiment;

FIG. 5 is a block diagram showing a functional configuration of the information processing apparatus according to this embodiment;

FIG. 6 is an illustration diagram showing one example of a configuration of a blink pattern storing unit corresponding to analyzed musical composition data;

FIG. 7 is an illustration diagram showing one example of a pattern shown in FIGS. 6 and 8;

FIG. 8 is an illustration diagram showing one example of the configuration of the blink pattern storing unit corresponding to the musical composition data, which is not analyzed;

FIG. 9 is a flowchart showing a musical composition analysis process according to this embodiment;

FIG. 10 is a flowchart showing light emission control process according to this embodiment;

FIG. 11 is an illustration diagram showing an example of light emission of a light emitting unit in chronological order; and

FIG. 12 is an illustration diagram showing an operating screen of a music playing application according to this embodiment.

### DETAILED DESCRIPTION OF EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

<Configuration of Information Processing Apparatus>

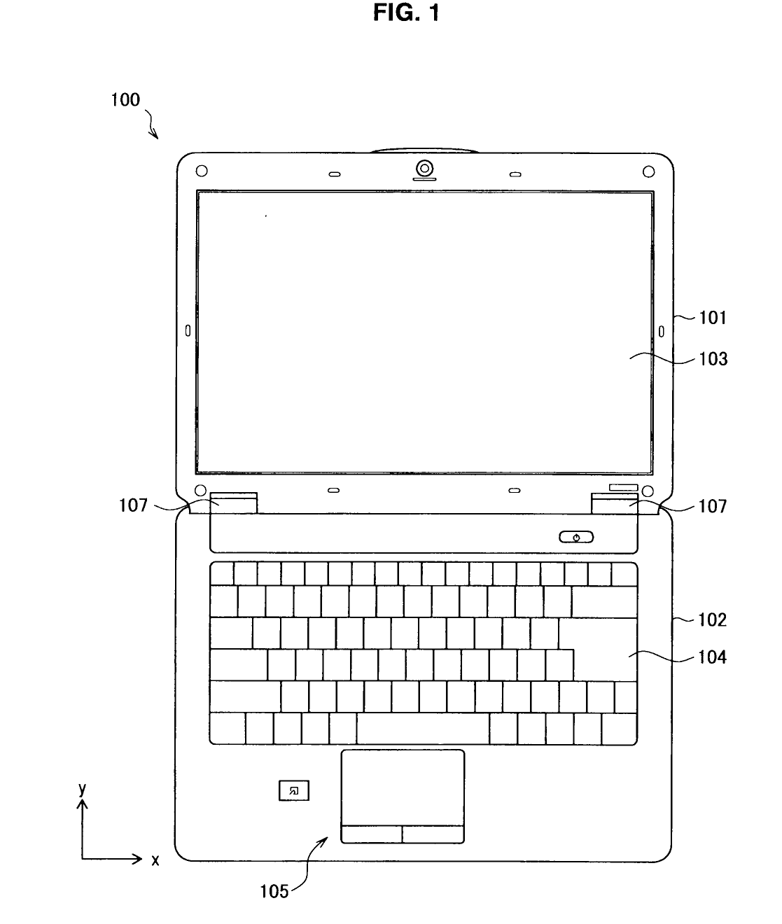

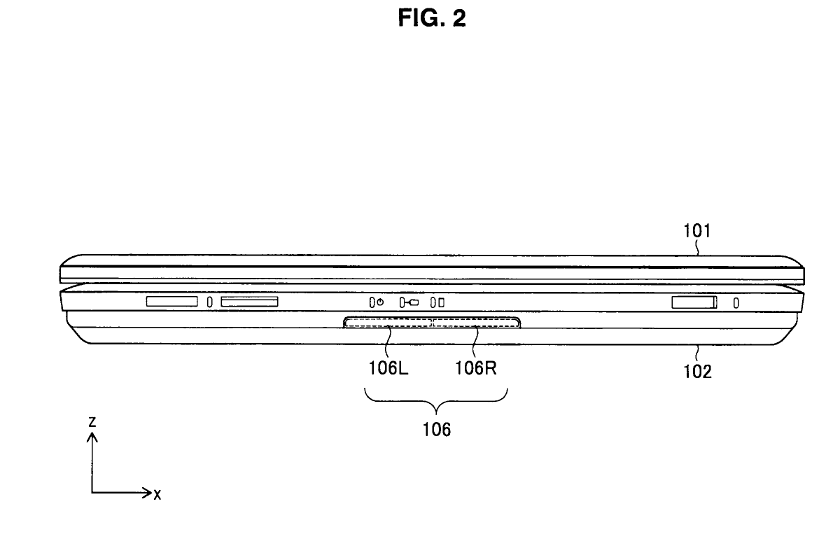

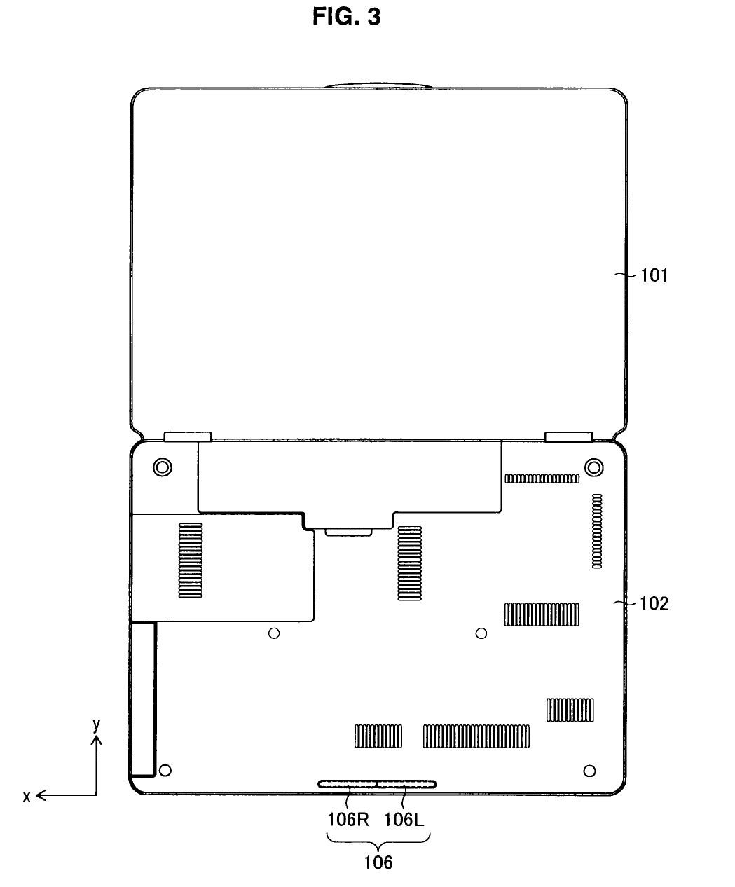

First, a configuration of an information processing apparatus according to an embodiment of the present invention is described with reference to FIGS. 1 to 3. Meanwhile, FIG. 1 is a plan view showing a personal computer, which is an example of an information processing apparatus 100 according to this embodiment, in an opened state. FIG. 2 is a front view showing the personal computer, which is an example of the information processing apparatus 100 according to this embodiment, in a closed state. FIG. 3 is a bottom view showing the personal computer, which is an example of the information processing apparatus 100 according to this embodiment, in the opened state.

The information processing apparatus 100 according to this embodiment is, for example, a notebook personal computer, formed of an upper surface portion 101 provided with a display unit 103 for displaying an image, video and the like, and a lower surface portion 102 provided with an input unit such as a keyboard 104 and a touchpad 105. The upper surface portion 101 and the lower surface portion 102 of the information processing apparatus 100 are connected so as to be opened and closed by means of a hinge portion 107. The information processing apparatus 100 according to this embodiment is provided with a light-emitting unit 106 formed of a right LED 106R and a left LED 106L on an outer surface of a front side of the lower surface portion 102, as shown in FIGS. 2 and 3. The light-emitting unit 106 emits light so as to correspond to musical composition data reproduced by a music playing application of the information processing apparatus 100.

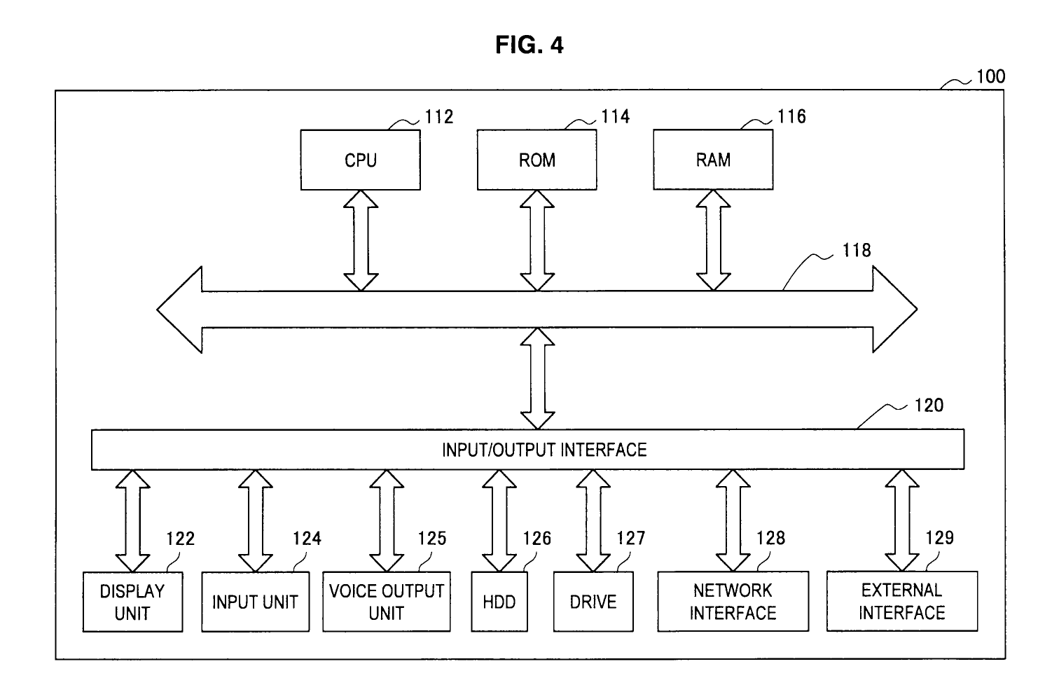

Next, a hardware configuration of the information processing apparatus 100 according to this embodiment is described with reference to FIG. 4. Meanwhile, FIG. 4 is an illustration diagram showing the hardware configuration of the information processing apparatus 100 according to this embodiment.

The information processing apparatus 100 according to this embodiment includes a CPU 112, a ROM 114, a RAM 116, an internal bus 118, an input/output interface 120, a display unit 122, an input unit 124, a voice output unit 125, a HDD 126, a drive 127, a network interface 128 and an external interface 120, as shown in FIG. 4.

The CPU 112 performs numerical calculations, information processing, device control and the like. The CPU 112 sequentially reads a program stored in the ROM 114 and data stored in the RAM 116 to execute the numerical calculations and the like. Also, the CPU 112 executes the numerical calculations and the like, based on, for example, an input signal corresponding to input information, which a user of the information processing apparatus 100 inputs from the input unit 122, and a signal received from an external server (not shown) and the like by means of the network interface 128.

The ROM 114 stores data, which is not changed basically, out of programs and parameters for calculation used by the CPU 112 when performing the numerical calculations, the information processing, the device control and the like. Also, the RAM 116 stores data, which appropriately changes basically in various processes, out of the programs and the parameters for calculation used when performing the numerical calculations, the information processing, the device control and the like.

The internal bus 118 is a pathway used for exchanging data within the information processing apparatus 100. The CPU 112, the ROM 114 and the RAM 116 are connected to one another by means of the internal bus 118. The internal bus 118 is also connected to the input/output interface 120. This makes it possible to transmit the input signal corresponding to the input information input from the input unit 124 and the signal received from the external server and the like by means of the network interface 128 to the CPU 112 through the internal bus 118.

The input/output interface 120 mediates an input output exchange of the information. The input/output interface 120 is connected to the display unit 122, the input unit 124, the voice output unit 125, the HDD 126, the drive 127, the network interface 128 and the external interface 129. The input/output interface 120 is also connected the internal bus 118 as described above. The input/output interface 120 transmits the input signal corresponding to the input information input from the input unit 124 and the signal received from the external server and the like by means of the network interface 128 to the CPU 112 through the internal bus 118.

The display unit 122 displays contents of the information input from the input unit 124, and information regarding a result of the numeric calculations, the information processing, the device control and the like by the CPU 112. The display unit 122 is formed of a CRT, a liquid crystal display device, an organic EL display device and the like, for example.

The input unit 124 is a functional unit operated by the user using the information processing apparatus 100 for inputting the information. The input unit 124 is formed of a mouse and a pen tablet and the like in addition to the keyboard 104 and the touchpad 105 shown in FIG. 1, for example.

The voice output unit 125 outputs voice generated in a process associated with a voice output when executing the process in the information processing apparatus 100. The voice output unit 125 according to this embodiment outputs a musical composition of the musical composition data being reproduced, for example.

The HDD 126 is a device for driving a hard disk provided inside thereof to record/reproduce the program read and executed by the CPU 112 and information. The drive 127 is a device to which a portable recording medium is attached for exchanging data between the attached recording medium and the information processing apparatus 100. As the portable recording medium, a magnetic disk, an optical disk, a magneto optical disk, a semiconductor memory and the like may be used, for example. At that time, the drive 127 may be the device, which may read the recording media.

The network interface 128 is a functional unit for exchanging the information with the external server. The external interface 129 is a functional unit for exchanging the information with a peripheral device used by being connected to the information processing apparatus 100. As the external interface 129, for example, a universal serial bus (USB) port and the like may be used. For example, the user may connect and use the information input device such as the keyboard and the mouse, which is an example of the input unit 124, to the external interface 129.

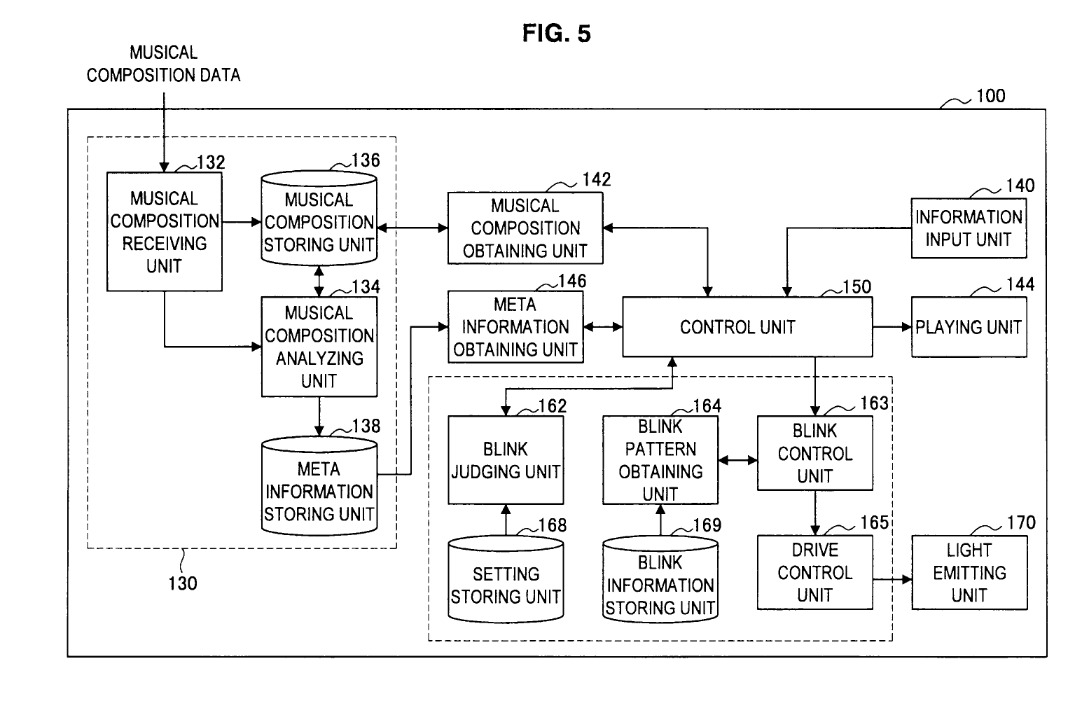

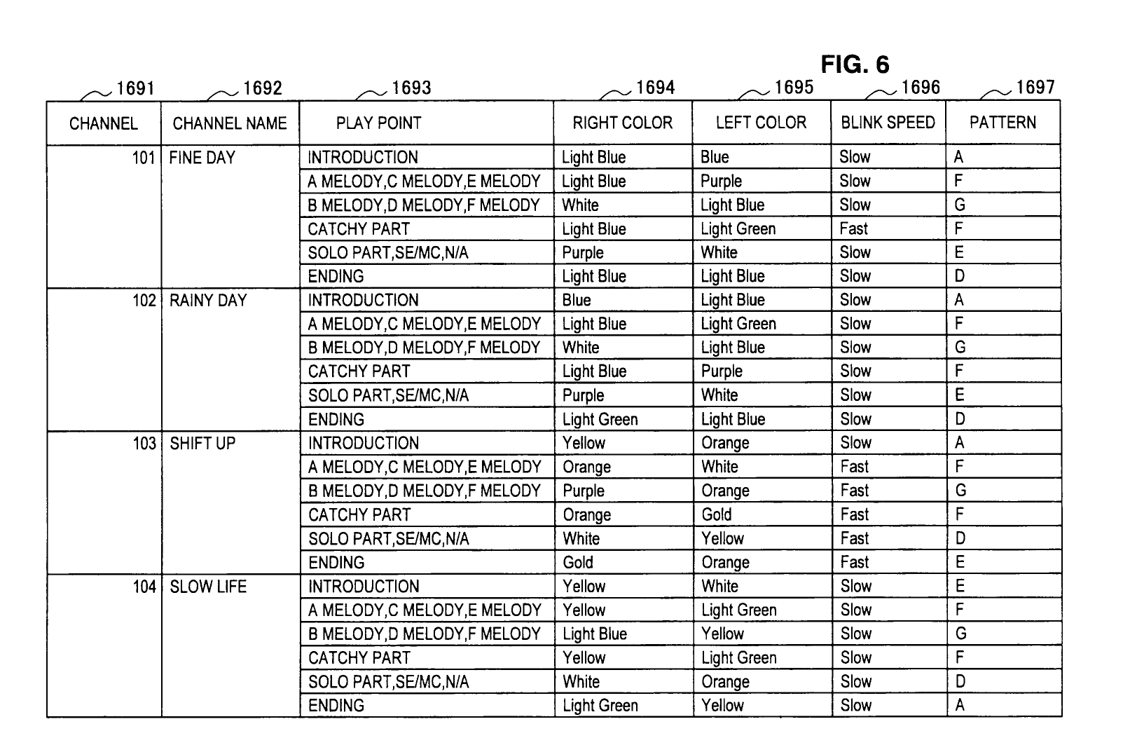

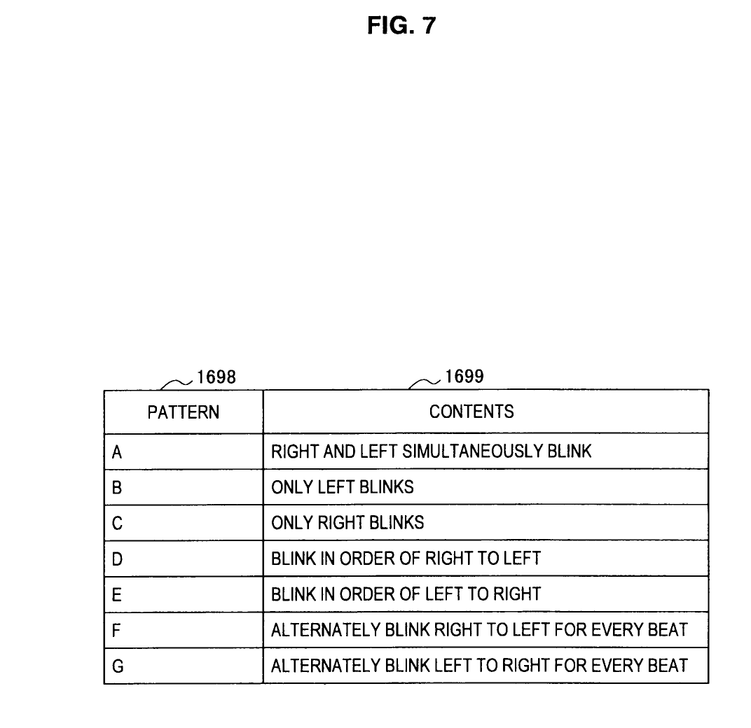

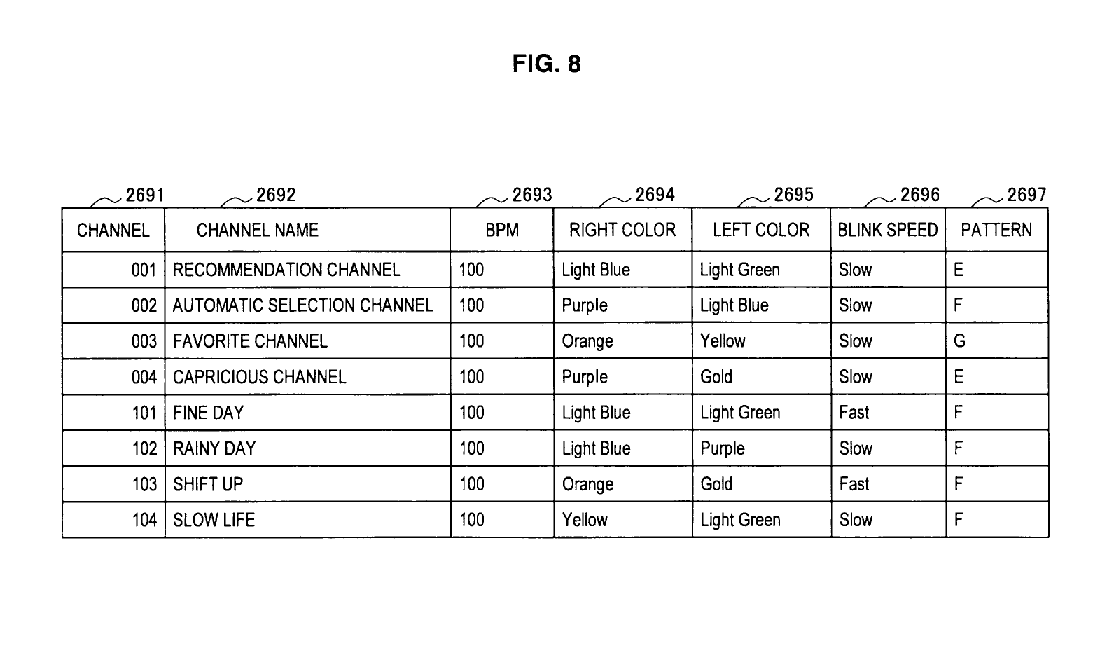

As above, the hardware configuration of the information processing apparatus 100 according to this embodiment is described. Next, a functional configuration of the information processing apparatus 100 according to this embodiment is described with reference to FIGS. 5 to 8. Meanwhile, FIG. 5 is a block diagram showing the functional configuration of the information processing apparatus 100 according to this embodiment. FIG. 6 is an illustration diagram showing one example of a configuration of a blink pattern storing unit 169 corresponding to analyzed musical composition data. FIG. 7 is an illustration diagram showing one example of a pattern shown in FIGS. 6 and 8. FIG. 8 is an illustration diagram showing one example of the configuration of the blink pattern storing unit 169 corresponding to the musical composition data, which is not analyzed.

The information processing apparatus 100 according to this embodiment includes a musical composition processing unit 130, an information input unit 140, a musical composition obtaining unit 142, a reproducing unit 144, a meta information obtaining unit 146, a control unit 150, a blink processing unit 160, and a light emitting unit 170, as shown in FIG. 5.

The musical composition processing unit 130 receives the musical composition data from the external server distributing the musical composition data, the recording medium and the like and analyzes the received musical composition data. The musical composition processing unit 130 includes a musical composition receiving unit 132, a musical composition analyzing unit 134, a musical composition storing unit 136 and a meta information storing unit 138, as shown in FIG. 5.

The musical composition receiving unit 132 receives the musical composition data from the external server, which distributes the musical composition data via the network, or from the external recording medium. The musical composition receiving unit 132 transmits the received musical composition data to the musical composition analyzing unit 134. Also, the musical composition receiving unit 132 records the received musical composition data to the musical composition storing unit 136.

The musical composition analyzing unit 134 analyzes the musical composition data to obtain information regarding a beat position, a tune and beats per minutes (BPM) and the like of the musical composition. By the analysis of the musical composition data by the musical composition analyzing unit 134, the information such as the beat position, the tune and the BPM information of the musical composition is obtained, for example, and at that time, the technique disclosed in Japanese Patent Application Laid-Open No. 2005-275068 may be used, for example. For that reason, the musical composition analyzing unit 134 according to this embodiment may be provided with an octave dividing unit for performing downsampling of an audio signal by dividing the same into a plurality of frequency ranges to divide into a plurality of octave signals, and a filtering unit for filtering the divided octave signals (both are not shown). The musical composition analyzing unit 134 generates meta information including the information regarding the musical composition obtained by analyzing the musical composition data to record in the meta information recording unit 138.

The musical composition storing unit 136 stores the received musical composition data. The musical composition storing unit 136 stores the musical composition data in a file format encoded by standards such as MP3 and ATRAC. The musical composition file obtained by converting the musical composition data to the file format includes basic information regarding the musical composition such as a name of an artist who performed the musical composition live, a name of single or album in which the musical composition is recorded, reproduction time, a name of a songwriter, a name of a composer, a release year, a category of the musical composition and the like, in addition to the musical composition. The musical composition storing unit 136 may be provided on the HDD 126, for example.

The meta information storing unit 138 stores the meta information generated by the musical composition analyzing unit 134. The meta information storing unit 138 stores the information regarding the beat position of the musical composition data, the tune, which is an amount of characteristic of the musical composition data, the BPM and the like as the meta information by associating the same with the musical composition. Herein, the amount of characteristic of the musical composition is an index indicating characteristics of the musical composition data. The beat position of the musical composition data may be specified by time as “00:00:01”, for example. Then, the tune, which is the amount of characteristic of the musical composition data, is associated with the beat position. By such configuration of the meta information, the tune at each beat position of the musical composition data may be grasped. The meta information storing unit 138 may be provided on, for example, the HDD 126. Meanwhile, although an example in which the tune, which is the amount of characteristic of the musical composition data, and the beat position are associated with each other is described, a configuration to store the position of the musical composition at predetermined intervals and the tune, which is the amount of characteristic of the musical composition data, by associating them with each other. According to this configuration, blink control of the light emitting unit 170 may be performed with a blink pattern, which suits the tune of the musical composition better, by setting the predetermined interval to be shorter than an interval of the beat, for example.

The information input unit 140 is a functional unit for the user using the information processing apparatus 100 to input the information. The information input unit 140 corresponds to the input unit 124 shown in FIG. 4. The information input unit 140 outputs the information input from the keyboard 104, the touchpad 105 and the like, shown in FIG. 1, for example to the control unit 150. For example, when the user reproduces a desired musical composition, information to specify the musical composition and a musical composition reproduction instruction and the like, for example, are transmitted from the information input unit 140 to the control unit 150.

The musical composition obtaining unit 142 obtains the musical composition data stored in the musical composition storing unit 136. The musical composition obtaining unit 142 receives a musical composition obtaining instruction from the control unit 150 to obtain the musical composition data from the musical composition storing unit 136. Then, the musical composition obtaining unit 142 obtains the musical composition data from the musical composition storing unit 136 based on the information to specify the musical composition included in the musical composition obtaining instruction, and transmits the obtained musical composition data to the control unit 150.

The reproducing unit 144 is a functional unit for reproducing the musical composition data. The reproducing unit 144 receives the musical composition data obtained by the control unit 150 to perform a reproduction process.

The meta information obtaining unit 146 is an interface for obtaining the meta information from the meta information storing unit 138. When the meta information obtaining unit 146 receives a meta information obtaining instruction for obtaining the meta information of the musical composition data to be reproduced from the control unit 150, this obtains the meta information from the meta information storing unit 138 based on the information to specify the musical composition included in the meta information obtaining instruction. Then, the meta information obtaining unit 146 transmits the obtained meta information to the control unit 150.

The control unit 150 performs control of an entire information processing apparatus 100 such as a musical composition obtaining process of the information processing apparatus 100 and a light emission control process of the light emitting unit 170. The control unit 150 transmits the musical composition obtaining instruction to the musical composition obtaining unit 142 to obtain the musical composition data based on the input information from the information input unit 140, and receives the musical composition data from the musical composition obtaining unit 142, for example. Then, the control unit 150 transmits the received musical composition data and a reproduction instruction to reproduce the musical composition data to the reproducing unit 144. Also, the control unit 150 controls the blink processing unit 160 for executing a blink process to blink the light emitting unit 170, for example.

The blink processing unit 160 is a functional unit for controlling the blink of the light emitting unit 170, and is formed of a blink judging unit 162, a blink control unit 163, a blink pattern obtaining unit 164, a drive control unit 165, a setting storing unit 168, and a blink pattern storing unit 169.

The blink judging unit 162 is a functional unit for judging whether to blink the light emitting unit 170. The blink judging unit 162 receives a blink judgment instruction from the controlling unit 150 to refer to the setting storing unit 168 in which setting information whether to blink the light emitting unit 170 (blink setting information) is stored. Then, the blink judging unit 162 transmits a judgment result to the controlling unit 150.

The blink control unit 163 is a functional unit for blinking the light emitting unit 170 based on the blink pattern. The blink control unit 163 receives a blink process execution instruction from the control unit 150 to transmit a blink pattern obtaining instruction to the blink pattern obtaining unit 164 to obtain the blink pattern. When the blink control unit 163 obtains the blink pattern from the blink pattern obtaining unit 164, this allows the drive control unit 165 to generate drive information to actually blink the light emitting unit 170.

The blink pattern obtaining unit 164 is a functional unit for obtaining the blink pattern from the blink pattern storing unit 169. The blink pattern obtaining unit 164 receives the blink process execution instruction from the blink control unit 163 to obtain the blink pattern from the blink pattern storing unit. Then, the blink pattern obtaining unit 164 transmits the obtained blink pattern to the blink control unit 163.

The drive control unit 165 generates the drive information to allow the light emitting unit 170 to emit light, and drives the light emitting unit 170. The drive control unit 165 generates the drive information to allow the light emitting unit 170 to emit light according to the blink pattern based on the blink pattern transmitted from the blink control unit 163. Then, the drive control unit 165 performs the light emission control of the light emitting unit 170 based on the generated drive information. The drive control unit 165 may include of, for example, a light emitting utility for generating the drive information to perform light emission drive of the light emitting unit 170 and a BIOS (for example, an embedded controller (EC)) for transmitting the drive information generated by the light emitting utility to the light emitting unit 170.

The setting storing unit 168 stores the setting information indicating the setting and the like of the process by each unit of the information processing apparatus 100. The setting storing unit 168 stores the blink setting information regarding whether to blink the light emitting unit 170, for example. Such setting information may be changed by the user by means of the information input unit 140.

The blink pattern storing unit 169 stores the blink pattern with which the light emitting unit 170 is allowed to emit light. The blink pattern storing unit 169 stores, for example, a channel 1691, a channel name 1692, a play point 1693, a right color 1694 indicating a light emission color of a right side on the light emitting unit 170, a left color 1695 indicating the light emission color of a left side of the light emitting unit 170, a blink speed 1696, and a pattern 1697, by associating them to one another as shown in FIG. 6. The channel 1691 is information to uniquely specify a classification pattern to classify the musical composition with a predetermined condition, and the channel name 1692 is a name of the classification pattern. The classification pattern of this embodiment is to classify the musical composition by an atmosphere of the musical composition such as “light musical composition” and “musical composition suited for a rainy day”, for example.

In each classification pattern, the light emission color, the blink speed, and the blink pattern of the light emitting unit 170 are defined according to the play point (information indicating parts of the musical composition such as an introduction, an A melody, a B melody, and a catchy part). The “color” suited for the atmosphere is assigned to each channel, and the information processing apparatus 100 allows the light emitting unit 170 to emit light with this color or a similar color. For example, to the channel “101” of the channel name “fine day”, the colors of white, light blue, blue, light green and purple are assigned, as shown in FIG. 6. In addition, the blink speed at each play point is determined according to the atmosphere of the musical composition. The blink speed may be set to approximately 0.5 second in a case of “slow” and to approximately 0.3 second in a case of “fast”, for example. That is to say, the blink pattern is determined by the channel (group of musical compositions with the similar tune) to which the musical composition is distributed according to the tune thereof, and the blink pattern also changes according to the part of the musical composition.

The blink pattern is set as shown in FIG. 7, for example. The light emitting unit 170 of the information processing apparatus according to this embodiment is formed of adjacently arranged two LEDs. For example, in FIG. 7, as the blink pattern of two LEDs, it is set to simultaneously blink right and left LEDs (pattern A), to blink only one of the right and left LEDs (patterns B and C), and to alternately blink the right and left LEDs (patterns D to G).

Meanwhile, as for the musical composition, which is not analyzed by the musical composition analyzing unit 134, and that distributed from a music distribution site through streaming, it is difficult to obtain the information such as the tune of the musical composition, so that it is difficult to allow the light emitting unit 170 to emit light with the light emitting pattern shown in FIG. 6. In this case, it is possible to allow the light emitting unit 170 to emit light with predetermined light emission color, blink speed, and blink pattern, as shown in FIG. 8, for example. At that time, the light emission color, the blink speed and the blink pattern when playing the catchy part as shown in FIG. 6, for example, may be used as the light emission color, the blink speed and the blink pattern of the light emitting unit 170. Also, a constant blink at a blink speed corresponding to BPM 100 (100 blinks per second), for example is possible.

In this manner, the blink pattern storing unit 169 stores the light emission color, the blink speed and the blink pattern of the light emitting unit 170 in accordance with the tune of the musical composition for every classification pattern to classify the musical composition by the atmosphere thereof.

The light emitting unit 170 emits light, and is formed of an LED, for example. The light emitting unit 170 according to this embodiment is provided as decorative lighting of the information processing apparatus 100. The light emitting unit 170 is driven by the drive control unit 165 based on the drive information, and emits light according to the blink pattern. The light emitting unit 170 according to this embodiment is formed of the adjacently arranged right and left two LEDs (corresponding to the left LED 106L and the right LED 106R shown in FIGS. 2 and 3). Each LED is light emission controlled by the drive control unit 165.

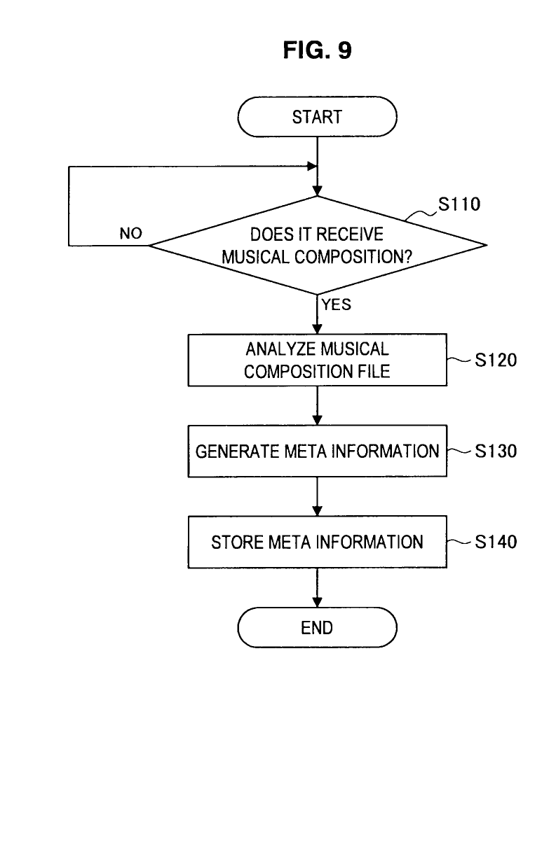

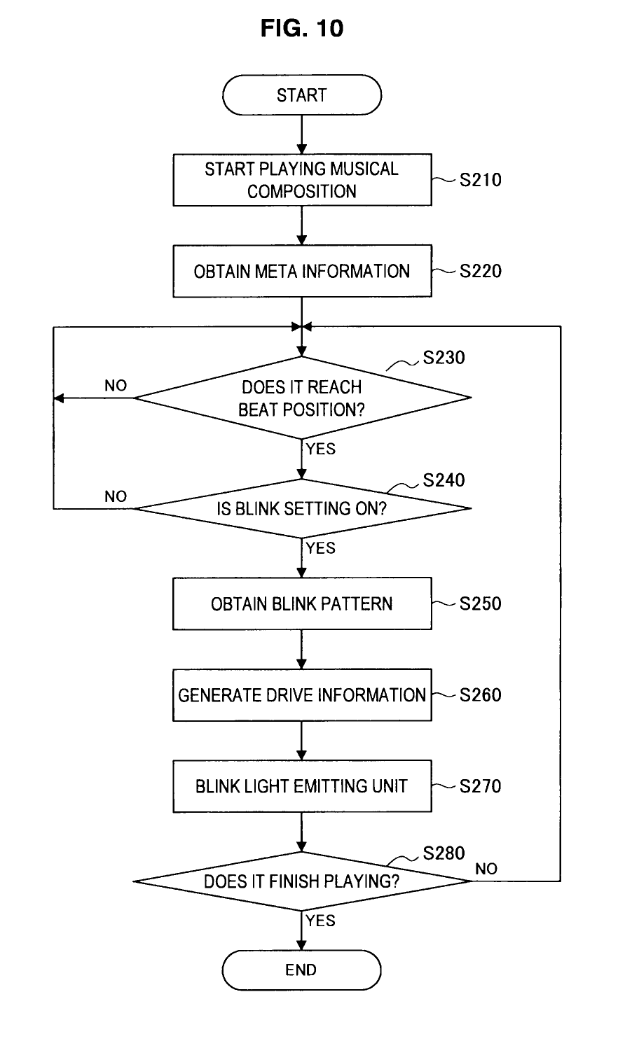

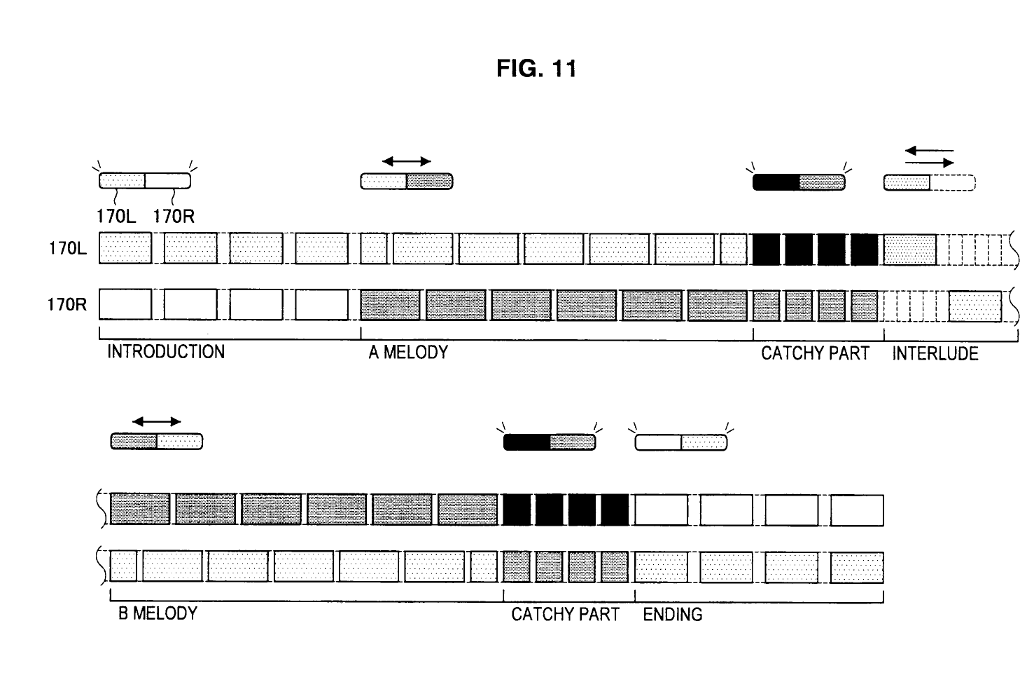

As above, the functional configuration of the information processing apparatus 100 according to this embodiment is described. The information processing apparatus 100 according to this embodiment blinks the light emitting unit 170 in accordance with the tune of the musical composition, which is one of the amounts of characteristic indicating the characteristics of the musical composition, along a time line when reproducing the musical composition data by using the music playing application. Then, a light emission control method of the light emitting unit 170 according to this embodiment is described with reference to FIGS. 9 to 11. Meanwhile, FIG. 9 is a flowchart showing a musical composition analysis process according to this embodiment. FIG. 10 is a flowchart showing the light emission control process according to this embodiment. FIG. 11 is an illustration diagram showing an example of light emission of the light emitting unit 170 in chronological order.

### <Music Analysis Process>

In the information processing apparatus 100 according to this embodiment, when blinking the light emitting unit 170 in accordance with the tune of the musical composition along the time line when reproducing the musical composition data, first, the musical composition data is analyzed. The musical composition analysis process according to this embodiment first judges whether to receive the musical composition data by the musical composition analyzing unit 134, as shown in FIG. 9 (step S110). The musical composition analyzing unit 134 judges whether to receive the musical composition data from the musical composition receiving unit 132, and when the musical composition analyzing unit 134 receives the musical composition data, this starts to analyze the musical composition data. On the other hand, when the musical composition analyzing unit 134 does not receive the musical composition data, the musical composition analyzing unit 134 waits for the reception of the musical composition data.

Next, when the musical composition analyzing unit 134 receives the musical composition data, this analyzes the musical composition data (step S120). The musical composition analyzing unit 134 may analyze the musical composition by using the technique disclosed in, for example, Japanese Patent Application Laid-Open No. 2005-275068.

Further, the musical composition analyzing unit 134 generates the meta information regarding the analyzed musical composition data (step S130). The musical composition analyzing unit 134 generates the meta information (the meta information is especially referred to as “time line meta information”) of the musical composition relating to the chronological order of the musical composition from the analysis result of the musical composition data performed at the step S120. The time line meta information includes, for example, the beat position of the musical composition, the tune information of the musical composition, the BPM information of the musical composition, and the like. The beat position of the musical composition is detected, for example, on the millisecond time scale. The tune information of the musical composition is, for example, the information such as the introduction, the A melody, the B melody, the catchy part, a solo part, a silent part and an ending. Also, the BPM information of the musical composition is a number of beats included in one second. Since the time line meta information includes the beat position of the musical composition indicating the position of the musical composition data and the tune information of the musical composition, which is the amount of characteristic at the beat position, it is possible to blink the light emitting unit 170 with right timing for the beat of the musical composition now being reproduced.

After that, the musical composition analyzing unit 134 records the generated meta information on the meta information storing unit 138 (step S140). The musical composition analyzing unit 134 records the time line meta information on the meta information storing unit 138 as the meta information file.

As above, the musical composition analysis process according to this embodiment is described. In this manner, the analysis process of the musical composition data is performed in advance in order to perform the blink process of the light emitting unit 170 linked to the reproduction process of the musical composition.

<Light Emission Control Process>

Next, the light emission control process of the light emitting unit 170 according to this embodiment is described with reference to FIG. 10. In the light emission control process according to this embodiment, as shown in FIG. 10, first, when the reproduction instruction of the musical composition is input and reproduction is started (step S210), the control unit 150 obtains the time line meta information, which is the meta information of the musical composition being reproduced (step S220). When the control unit 150 receives the reproduction instruction of the musical composition, this transmits an instruction to obtain the time line meta information of the musical composition to the meta information obtaining unit 146. The meta information obtaining unit 146 obtains the time line meta information of the musical composition data from the meta information storing unit 138 based on the instruction from the control unit 150. Then, the meta information obtaining unit 146 transmits the obtained time line meta information to the control unit 150. This allows the control unit 150 to obtain the information relating to the chronological order of the musical composition, which is the beat position of the musical composition data and the tune of the musical composition data at the beat position, for the musical composition being reproduced.

Next, the control unit 150 judges whether a reproduction position of the musical composition being reproduced reaches the beat position (step S230). The control unit 150 serves as a tune judging unit to judge the tune, and judges whether the reproduction position of the musical composition being reproduced reaches the beat position every predetermined number of beats, for example, every one beat. The beat position may be judged every predetermined time (for example, 1 msec). The control unit 150 judges that the reproduction position of the musical composition being reproduced reaches the beat position, for example, when the tune of the musical composition changes from the introduction to the A melody, and executes a subsequent process. On the other hand, when the control unit 150 judges that the reproduction position does not reach the beat position, this repeats the process at the step S230 until the reproduction position reaches the beat position.

Further, when it is judged that the reproduction position reaches the beat position at the step S230, it is judged whether to blink the light emitting unit 170 (step S240). When the reproduction position reaches the beat position, the drive control unit 165 transmits to the blink judging unit 162 the blink judgment instruction to allow the same to judge whether to blink the light emitting unit 170. The blink judging unit 162, which receives the blink judgment instruction, refers to the setting storing unit 168 in which the blink setting information, which is the setting information whether to blink the light emitting unit 170, is stored to confirm on/off of the setting. Then, the blink judging unit 162 judges to blink the light emitting unit 170 when the setting is on, and judges not to blink the light emitting unit 170 when the setting is off. The blink judging unit 162 transmits the judgment result to the control unit 150. The control unit 150, which receives the judgment result, executes the subsequent process when blinking the light emitting unit 170, and returns to the step S230 when not blinking the light emitting unit 170 to execute the processes from the step S230 again.

When it is judged to allow the light emitting unit 170 to emit light at the step S240, the blink pattern of the musical composition being reproduced is obtained by the blink pattern obtaining unit 164 so as to blink the light emitting unit 170 according to the pattern corresponding to the atmosphere of the musical composition being reproduced (step S250). When the control unit 150 transmits a light emission instruction to allow the light emitting unit 170 to emit light to the blink control unit 163, the blink control unit 163 allows the blink pattern obtaining unit 164 to obtain the blink pattern of the musical composition being reproduced. The blink pattern obtaining unit 164 obtains the blink pattern of the musical composition (such as the right color 1694, the left color 1695, the blink speed 1696 and the pattern 1697, shown in FIG. 6) corresponding to a current beat position (play point) from the blink pattern storing unit 169 based on the channel name and the beat position to transmit to the blink control unit 163. Then, the blink control unit 163 transmits the blink pattern received from the blink pattern obtaining unit 164 to the blink control unit 163.

Further, when the blink pattern of the musical composition being reproduced is obtained by the blink pattern obtaining unit 164, the drive control unit 165 generates the drive information to perform the light emission drive of the light emitting unit 1 70 based on the blink pattern (step S260). When the drive control unit 165 receives the blink pattern from the blink control unit 163, this generates the drive information to drive the light emitting unit 170 such that the light emitting unit 170 blinks according to the blink pattern. That is to say, the blink control unit 163 transmits the blink color of the light emitting unit 170, the blink pattern corresponding to the tune of the musical composition, the blink speed and the like to the drive control unit 165. The drive control unit 165 generates the drive information to allow the light emitting unit 170 to emit light based on the information received from the blink control unit 163.

Then, the drive control unit 165 drives the light emitting unit 170 based on the drive information. Thereby, the light emitting unit 170 blinks in accordance with the tune of the musical composition now being reproduced (step S270).

Thereafter, it is judged whether the reproduction process of the musical composition now being reproduced is finished (step S280). When the control unit 150 judges that the reproduction process is not finished, this returns to the step S230 to execute the processes from the step S230. On the other hand, when the control unit 150 judges that the reproduction process is finished, this finishes the light emission control process of the light emitting unit 170.

As above, the light emission control process of the light emitting unit 170 according to this embodiment is described. In this manner, according to the light emission control process according to this embodiment, it is possible to blink the light emitting unit 170 in accordance with the beat position by judging whether to blink the light emitting unit 170 every predetermined number of beats to perform the blink process. By sequentially performing such process from a top beat and repeating to wait until a next beat position when the process at the beat position at the present moment is finished to the end of the musical composition reproduction, the blink of the light emitting unit 170 completely suiting for the reproduction process of the musical composition may be realized. Suppose that the information processing apparatus 100 falls into a high-load state by some reason during the reproduction of the musical composition, and cooperation between the musical composition reproduction and the blink of the light emitting unit 170 is temporarily shifted. However, the process is performed every predetermined number of beats in the light emission control process according to this embodiment, so that the state may be easily recovered so as to blink the light emitting unit 170 again at an appropriate position when the high-load state is eased.

Herein, an example of a case in which the light emitting unit 170 is allowed to emit light based on the light emission control process according to this embodiment is shown in FIG. 11. In FIG. 11, the right LED arranged on the right side of the light emitting unit 170 is indicated by a reference numeral 170R (corresponding to the right LED 106R in FIGS. 2 and 3) and the left LED arranged on the left side thereof is indicated by the reference numeral 170L (corresponding to the left LED 106L in FIGS. 2 and 3). Also, an abscissa axis is a time axis and change in the tune of the musical composition is represented along the abscissa.

In the musical composition shown in FIG. 11, first, the left LED 170L and the right LED 170R simultaneously blink at a slower speed in the introduction. At that time, the left LED 170L shines light blue and the right LED 170R shines white, for example. Next, in the A melody, the control unit 150 allows the blink judging unit 162 to operate to confirm the blink setting information, and thereafter, obtains the blink pattern in the A melody by the blink pattern obtaining unit 164. Then, the control unit 150 alternately blinks the light emitting unit 170 at a faster speed in order of the left LED 170L to the right LED 170R every one beat according to the blink pattern by the blink control unit 163. At that time, the left LED 170L shines blue and the right LED 170R shines light blue, for example. Then, in the catchy part of the musical composition, the control unit 150 confirms the blink setting information in the same manner, and thereafter obtains the blink pattern in the catchy part, and simultaneously blinks the left LED 170L and the right LED 170R at a faster speed according to the blink pattern. At that time, the left LED 170L shines purple and the right LED 170R shines blue, for example.

Thereafter, in an interlude, the control unit 150 allows the blink judging unit 162 to operate and confirms the blink setting information again, and thereafter, this obtains the blink pattern in the interlude by the blink pattern obtaining unit 164. Then, the control unit 150 alternately blinks the light emitting unit 170 at a slower speed, such that the left LED 170L and the right LED 170R alternately blink every alternative beat, according to the blink pattern by the blink control unit 163. At that time, the left LED 170L shines light green and the right LED 170R shines light blue, for example. Then, in the B melody, the control unit 150 allows the blink judging unit 162 to operate and confirms the blink setting information, and thereafter, obtains the blink pattern in the B melody by the blink pattern obtaining unit 164. Then, the control unit 150 alternately blinks the light emitting unit 170 at a faster speed in order of the right LED 170R to the left LED 170L every one beat according to the blink pattern by the blink control unit 163. At that time, the left LED 170L shines light blue and the right LED 170R shines blue, for example. In the catchy part of the musical composition, the control unit 150 confirms the blink setting information and thereafter obtains the blink pattern in the catchy part, and simultaneously blinks the left LED 170L and the right LED 170R at a faster speed according to the blink pattern as in the case of the previously appeared catchy part. At that time, the left LED 170L shines purple and the right LED 170R shines blue, for example.

Thereafter, in the ending, the control unit 150 allows the blink judging unit 162 to operate to confirm the blink setting information, and thereafter, obtains the blink pattern in the ending by the blink pattern obtaining unit 164. Then, the control unit 150 simultaneously blinks the left LED 170L and the right LED 170R at a slower speed according to the blink pattern by the blink control unit 163. At that time, the left LED 170L shines white and the right LED 170R shines light blue, for example.

In this manner, according to the light emission control process of the light emitting unit 170 according to this embodiment, it is possible to blink the light emitting unit 170 according to the tune of the musical composition along the time line of the musical composition by using the time line meta information. In this manner, by allowing the hardware and the music playing application of the information processing apparatus 100 to cooperate with each other, sense of unity between the hardware of a body and a musical composition reproduction function may be generated, thereby improving immersive feeling of the user in looking at and listening to the music.

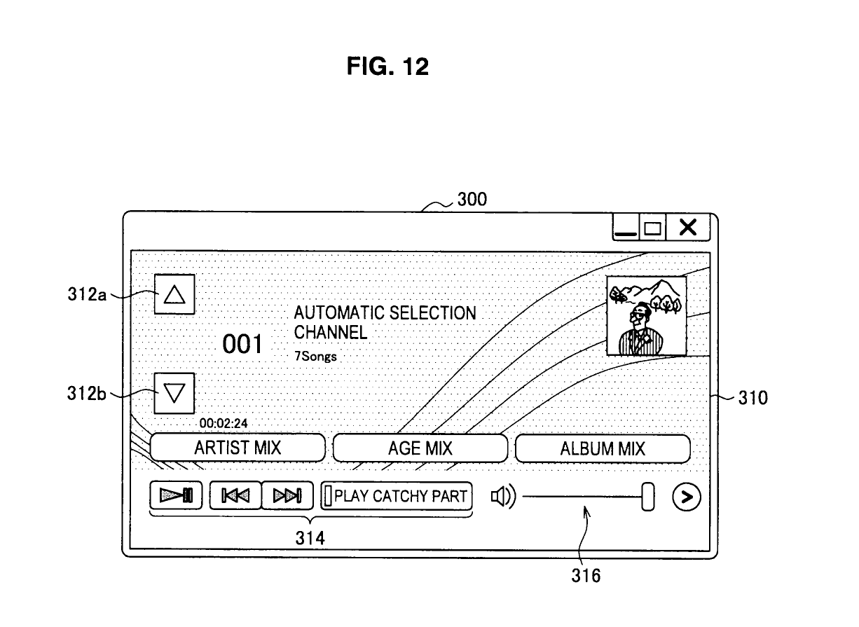

Meanwhile, the information processing apparatus 100 according to this embodiment may set a background color 310 of the operating screen 300 of the music playing application to the color corresponding to the blink pattern of the light emitting unit 170, as shown in FIG. 12, for example. The operating screen 300 is an interface for performing the operation such as the reproduction of the musical composition, as shown in FIG. 12. The operating screen 300 is provided with selection keys 312a and 312b for selecting the classification pattern, an operation key 314 for performing operations such as play, pause, fast-forward and fast-rewind of the musical compositions and play of only the catchy part of the musical composition, a volume control bar 316 and the like, for example. Herein, the colors of the background color 310 and the selection keys 312a and 312b of the operating screen 300 may be set to predetermined colors every classification pattern, for example, and the colors may be changed according to the color of the beat position of the classification pattern. In this manner, by providing a relation between the blink pattern of the light emitting unit 170 and the screen and the like relating to a music playing function, it is possible to provide the sense of unity by the blink of the light emitting unit 170 and the musical composition reproduction process.

It should be understood by those skilled in the art that various modifications, combinations, sub-combinations and alterations may occur depending on design requirements and other factors insofar as they are within the scope of the appended claims or the equivalents thereof.

For example, although the time line meta information is generated as a separate file aside from the musical composition data and is recorded in the meta information storing unit 138 in the above-described embodiment, the present invention is not limited to such embodiment. For example, the time line meta information may be stored by being embedded in the musical composition data. In this case, the time line meta information is stored in the musical composition storing unit 136 together with the musical composition data, and the meta information obtaining unit 146 accesses the musical composition storing unit 136 to obtain the time line meta information. The user may determine whether to store the meta information as the separate file or to store the same by embedding in the musical composition data by selecting a desired format to set a music analyzing engine.

Also, although the light emitting unit 170 emits light according to the blink pattern based on the classification pattern of the musical composition being reproduced in the above-described embodiment, the present invention is not limited to such embodiment. For example, a process not to blink the light emitting unit 170 in a silent part in the musical composition being reproduced may be added. Thereby, it is possible to further provide the sense of unity between the musical composition reproduction process and the blink of the light emitting unit 170.

Further, although it is judged whether to reach the beat position at every predetermined number of beats or at every predetermined time, and the amount of characteristic of the musical composition data is obtained/judged when it is judged to reach the beat position to blink the light emitting unit in the above-described embodiment, the present invention is not limited to such embodiment. The present invention is to blink the light emitting unit so as to conform to the timing of the musical composition now being reproduced by obtaining/judging the amount of characteristic of the musical composition data each time with predetermined timing. Therefore, for example, it is possible to obtain/judge the amount of characteristic of the musical composition data every predetermined time to control such that the light emitting unit blinks according to the amount of characteristic.

Also, although the tune (the tune itself of each musical composition or the group of the musical compositions having the same tune) of the musical composition is used as the amount of characteristic of the musical composition in the above-described embodiment, the present invention is not limited to such embodiment. For example, it is also possible to use a speed of the musical composition as the amount of characteristic of the musical composition and changes the blink speed (blink pattern) according to the speed of the musical composition. For example, it is possible to change such that the blink of the light emitting unit is made faster in a case of a speedy musical composition, and the blink of the light emitting unit is made slower in a case of a slow musical composition.

The present application contains subject matter related to that disclosed in Japanese Priority Patent Application JP 2008-216152 filed in the Japan Patent Office on Aug. 26, 2008, the entire content of which is hereby incorporated by reference.

What is claimed is:

1. An information processing apparatus, comprising:
a musical composition storing unit for storing musical composition data;
a reproducing unit for reproducing the musical composition data;
a meta information storing unit for storing meta information including a position of the musical composition data and an amount of characteristic indicating characteristics of the musical composition data at the position;
an amount of characteristic obtaining unit for obtaining the amount of characteristic at a reproduction position of the musical composition data reproduced by the reproducing unit at predetermined timing; and
a blink control unit for controlling a blink of a light emitting unit for emitting light according to the amount of characteristic obtained by the amount of characteristic obtaining unit.

2. The information processing apparatus according to claim 1,
wherein the meta information includes information regarding a beat being associated with the position of the musical composition data, and
the amount of characteristic obtaining unit obtains the amount of characteristic of the musical composition data at timing of the beat.

3. An information processing apparatus, comprising:
a musical composition storing unit for storing musical composition data;
a reproducing unit for reproducing the musical composition data;
a meta information obtaining unit for obtaining meta information in which information regarding reproduced musical composition data being the musical composition data being reproduced by the reproducing unit is described;
a judging unit for judging change in an amount of characteristic indicating characteristics of the reproduced musical composition data at predetermined timing based on the meta information obtained by the meta information obtaining unit; and
a blink control unit for controlling a blink of a light emitting unit for emitting light when the amount of characteristic of the reproduced musical composition data changes.

4. The information processing apparatus according to claim 3, further comprising:
a blink information storing unit for associating a classification pattern to classify the musical composition data with a predetermined condition and a blink pattern to blink the light emitting unit with each other to store; and
a blink pattern obtaining unit for obtaining the blink pattern;
wherein the blink control unit controls the blink of the light emitting unit based on the blink pattern of the reproduced musical composition data obtained by the blink pattern obtaining unit.

5. The information processing apparatus according to claim 4,
wherein the blink pattern is determined according to a tune of the musical composition data.

6. The information processing apparatus according to claim 5,
wherein the blink control unit does not blink the light emitting unit in a silent part present in the musical composition data being reproduced by the reproducing unit.

7. The information processing apparatus according to claim 3, further comprising:
a blink judging unit for judging whether to allow the light emitting unit to emit light;
wherein the blink judging unit judges when the amount of characteristic of the reproduced musical composition data changes, and
the control unit controls the blink of the light emitting unit only when it is judged to allow the light emitting unit to emit light by the blink judging unit.

8. The information processing apparatus according to claim 3, further comprising:
a musical composition analyzing unit for analyzing the musical composition data to obtain information regarding the musical composition data;
wherein the musical composition analyzing unit generates the meta information in which the information regarding the musical composition data is described.

9. The information processing apparatus according to claim 8,
wherein the blink control unit allows the light emitting unit to emit light based on a predetermined blink pattern set in advance when the musical composition data is not analyzed by the musical composition analyzing unit.

10. The information processing apparatus according to claim 8,
wherein the musical composition analyzing unit stores the generated meta information in the musical composition storing unit together with the musical composition data.

11. The information processing apparatus according to claim 8, further comprising:
a meta information storing unit for associating the meta information in which the information regarding the musical composition data is described and the musical composition data with each other to store;
wherein the musical composition analyzing unit records the generated meta information in the meta information storing unit, aside from the musical composition data.

12. The information processing apparatus according to claim 3, further comprising:
a display unit for displaying an operating screen for operating the reproducing unit;
wherein a color tone of the operating screen is changed according to a classification pattern of the reproduced musical composition data.

13. A light emission control method, comprising the steps of:
storing musical composition data;
reproducing the musical composition data;
recording meta information including a position of the musical composition data and an amount of characteristic indicating characteristics of the musical composition data at the position in a meta information storing unit;
obtaining the amount of characteristic at a reproduction position of the musical composition data reproduced at predetermined timing; and
controlling a blink of a light emitting unit for emitting light according to the obtained amount of characteristic.

14. A computer program for allowing a computer to operate as:
storing means for storing musical composition data;
reproducing means for reproducing the musical composition data;
meta information recording means for recording meta information including a position of the musical composition data and an amount of characteristic indicating characteristics of the musical composition data at the position in a meta information storing unit;
amount of characteristic obtaining means for obtaining the amount of characteristic at a reproduction position of the musical composition data reproduced by the reproducing means at predetermined timing; and
blink control means for controlling a blink of a light emitting unit for emitting light according to the amount of characteristic obtained by the amount of characteristic obtaining means.
